(19) United States
(12) Patent Application Publication
(10) Pub. No.: US 2024/0289667 A1
(43) Pub. Date: Aug. 29, 2024

(54) ANNEALING TRAINING OF QUANTUM CIRCUITS ON HYBRID QUANTUM-CLASSICAL COMPUTING SYSTEM

(71) Applicant: IONQ, INC., College Park, MD (US)

(72) Inventors: Daiwei ZHU, Chicago, IL (US); Sonika JOHRI, Cupertino, CA (US)

(21) Appl. No.: 18/379,540

(22) Filed: Oct. 12, 2023

Related U.S. Application Data
(60) Provisional application No. 63/418,967, filed on Oct. 24, 2022.

(51) Int. Cl. G06N 10/40

(52) U.S. Cl. CPC G06N 10/40

(57) ABSTRACT

A method of performing computation includes selecting samples of a set of variables and a target joint distribution, selecting a set of variational parameters to construct a parametrized quantum circuit, executing iterations, each iteration including applying the parametrized quantum circuit to the quantum processor based on the set of the variational parameters, to transform the quantum processor from an initial state to a trial state, measuring an amplitude of the trial state, to generate a trial joint distribution, and replacing the set of the variational parameters with another set of variational parameters, if a difference between the generated trial joint distribution and an adaptive target joint distribution is more than a predetermined value, and outputting the set of the variational parameters. The adaptive target joint distribution is a mixture of a uniform joint distribution with the target joint distribution, and a mixing coefficient is decreased in each iteration.

### CROSS-REFERENCE TO RELATED APPLICATIONS

This application claims priority to U.S. Provisional Application Ser. No. 63/418,967 filed Oct. 24, 2022, which is herein incorporated by reference in its entirety.

### BACKGROUND

### Field

The present disclosure generally relates to a method of performing computation in a hybrid quantum-classical computing system, and more specifically, to a method of solving an optimization problem in a hybrid computing system that includes a classical computer and a quantum computer that includes trapped ions.

### Description of the Related Art

In current state-of-the-art quantum computers, control of qubits is imperfect (noisy) and the number of qubits used in these quantum computers generally range from a hundred qubits to thousands of qubits. The number of quantum gates that can be used in such a quantum computer (referred to as a “noisy intermediate-scale quantum device” or “NISQ device”) to construct circuits to run an algorithm within a controlled error rate is limited due to the noise.

For solving some optimization problems, a NISQ device having shallow circuits (with small number of gate operations to be executed in time-sequence) can be used in combination with a classical computer (referred to as a hybrid quantum-classical computing system). For example, a classical computer (also referred to as a “classical optimizer”) instructs a controller to execute quantum gate operations on a NISQ device (also referred to as a “quantum processor”) and measure an outcome of the quantum processor. Subsequently, the classical optimizer instructs the controller to prepare the quantum processor in a slightly different state, and repeats execution of the gate operation and measurement of the outcome. This cycle is repeated until the approximate solution can be extracted. Such hybrid quantum-classical computing system having an NISQ device may outperform classical computers in finding approximate solutions to such optimization problems. However, classical optimization, as a critical part of a hybrid quantum-classical computation, often runs into issues, such as bad local minima and vanishing gradients.

Therefore, there is a need for improved methods for solving optimization problems on a hybrid quantum-classical computing system.

### SUMMARY

Embodiments of the present disclosure provide a method of performing computation in a hybrid quantum-classical computing system comprising a classical computer and a quantum processor. The method includes selecting, by a classical computer, samples of a set of variables and a target joint distribution of the set of variables, selecting, by the classical computer, a set of variational parameters to construct a parametrized quantum circuit, executing iterations, each iteration including setting, by a system controller, a quantum processor in an initial state, wherein the quantum processor comprises a plurality of trapped ions, each of which has two frequency-separated states defining a qubit, applying, by the system controller, the parametrized quantum circuit to the quantum processor based on the set of the variational parameters, to transform the quantum processor from the initial state to a trial state, measuring, by the system controller, an amplitude of the trial state, to generate a trial joint distribution of the set of variables, and replacing, by the classical computer, the set of the variational parameters with another set of variational parameters, if a difference between the generated trial joint distribution of the set of variables and an adaptive target joint distribution based on the target joint distribution and a mixing coefficient is more than a predetermined value, and outputting the set of the variational parameters. The adaptive target joint distribution is a mixture of a uniform joint distribution of the set of variables with the target joint distribution, and the mixing coefficient is decreased in each iteration.

Embodiments of the present disclosure also provide a hybrid quantum-classical computing system. The comprising hybrid quantum-classical computing system includes a quantum processor comprising a plurality of trapped ions, each of the trapped ions having two hyperfine states defining a qubit, one or more lasers configured to emit a laser beam, which is provided to trapped ions in the quantum processor, a classical computer configured to select samples of a set of variables and a target joint distribution of the set of variables, select a set of variational parameters to construct a parametrized quantum circuit, execute iterations, each iteration including instructing a system controller to set the quantum processor in an initial state, instructing the system controller to apply the parametrized quantum circuit to the quantum processor based on the set of the variational parameters, to transform the quantum processor from the initial state to a trial state, instructing the system controller to measure an amplitude of the trial state, to generate a trial joint distribution of the set of variables, and replacing the set of the variational parameters with another set of variational parameters, if a difference between the generated trial joint distribution of the set of variables and an adaptive target joint distribution based on the target joint distribution and a mixing coefficient is more than a predetermined value, and output the set of the variational parameters. The adaptive target joint distribution is a mixture of a uniform joint distribution of the set of variables with the target joint distribution, and the mixing coefficient is decreased in each iteration.

Embodiments of the present disclosure further provide a hybrid quantum-classical computing system comprising non-volatile memory having a number of instructions stored therein. The number of instructions, when executed by one or more processors, causes the hybrid quantum-classical computing system to perform operations including selecting, by a classical computer, samples of a set of variables and a target joint distribution of the set of variables, selecting, by the classical computer, a set of variational parameters to construct a parametrized quantum circuit, executing iterations, each iteration including setting, by a system controller, a quantum processor in an initial state, wherein the quantum processor comprises a plurality of trapped ions, each of which has two frequency-separated states defining a qubit, applying, by the system controller, the parametrized quantum circuit to the quantum processor based on the set of the variational parameters, to transform the quantum processor from the initial state to a trial state, measuring, by the system controller, an amplitude of the trial state, to generate a trial joint distribution of the set of variables, and replacing, by the classical computer, the set of the variational parameters with another set of variational parameters, if a difference between the generated trial joint distribution of the set of variables and an adaptive target joint distribution based on the target joint distribution and a mixing coefficient is more than a predetermined value, and outputting the set of the variational parameters. The adaptive target joint distribution is a mixture of a uniform joint distribution of the set of variables with the target joint distribution, and the mixing coefficient is decreased in each iteration.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3 depicts a flowchart illustrating a method of obtaining a solution to an optimization problem by annealing training based on copulas on a hybrid quantum-classical computing system according to one embodiment.

FIG. 4A illustrates a parameterized quantum circuit according to one embodiment.

FIG. 4B illustrates a parameterized quantum circuit unit according to one embodiment.

FIGS. 5A, 5B, 5C, and 5D illustrate comparison results of the annealing training method and a conventional training method without annealing training. To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Embodiments described herein are generally related to a method and a system for performing a computation using a hybrid quantum-classical computing system, and, more specifically, to providing an approximate solution to an optimization problem using a hybrid quantum-classical computing system that includes a group of trapped ions.

In the embodiments described herein, an annealing training method for obtaining a solution to an optimization problem on a hybrid quantum-classical computing system is provided. In the annealing training method, a parameterized quantum circuit is “trained” so as to provide a target solution Q₀ using an adaptive target Q(η)=ηu+(1−η)Q₀ (0<η≤1), where u is a noise (e.g., a known value) and η is an annealing temperature. The training of the parameterized quantum circuit starts with a relatively high annealing temperature η and continues with gradually lowering the annealing temperature η, analogous to adiabatic thermal annealing. Thus, the annealing training provides reliable solutions to optimization problems, without issues such as bad local minima and vanishing gradients that are common in conventional optimization methods.

### General Hardware Configurations

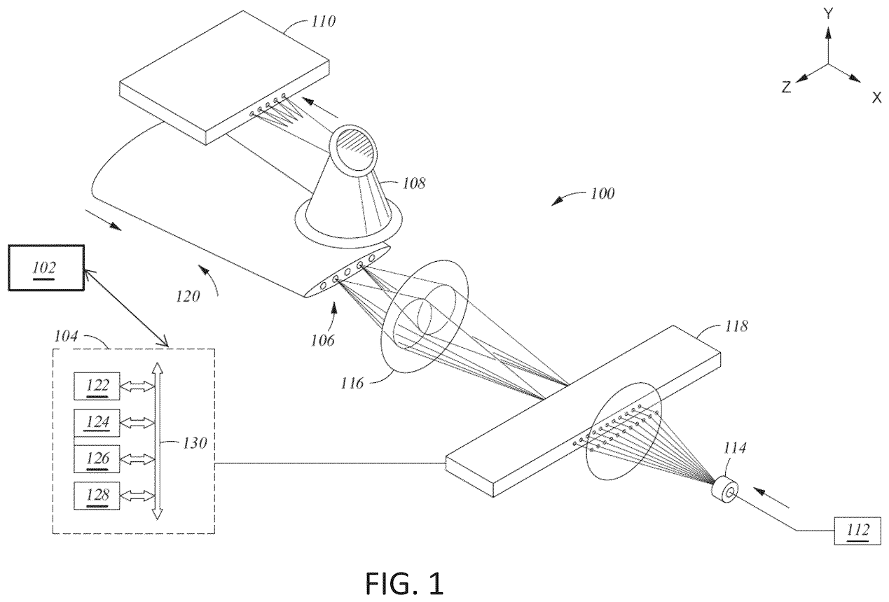

FIG. 1 is a schematic partial view of an ion trap quantum computing system, or system 100, according to one embodiment. The system 100 includes a classical (digital) computer 102, a system controller 104 and a quantum processor that is an ion chain 106 having trapped ions (i.e., five shown) that extend along the Z-axis. The classical computer 102 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

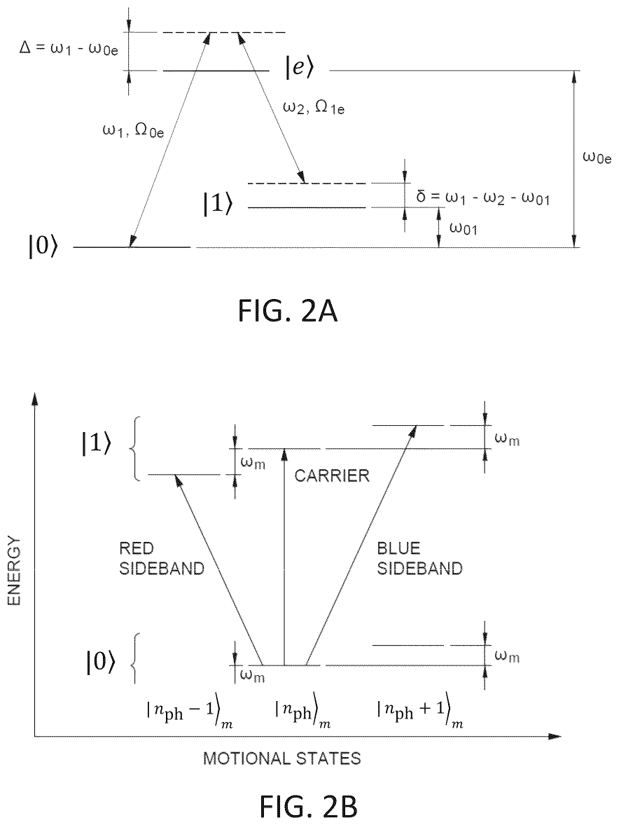

FIG. 2A depicts a schematic energy diagram of each ion in the ion chain 106 according to one embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.6 GHZ. A qubit is formed with the two hyperfine states, used to represent computational basis |0 [symbol] and |1 [symbol] (|i [symbol] (i∈Z)), where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z)). Each ion may be cooled (i.e., kinetic energy of the ion may be reduced) to near the motional ground state |0 [symbol] ₘ for any motional mode m with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] ). As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀ₑ between |0 [symbol] and |e [symbol] , as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg⁺, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=μ>0, referred to as a blue sideband), Rabi flopping between combined qubit-motional states |0 [symbol] |nph) and |1 [symbol] |nₚₕ+1 [symbol] ₘ occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ [symbol] ₘ, δ=ω₁−ω₂−ω₀₁=μ>0, referred to as a red sideband), Rabi flopping between combined qubit-motional states |0 [symbol] |nₚₕ [symbol] ₘ and |1 [symbol] |nₚₕ−1 [symbol] ₘ occurs (i.e., a transition from the motional mode |nₚₕ [symbol] ₘ to the motional mode |nₚₕ−1 [symbol] ₘ with one less phonon excitations occurs when the qubit state |0 [symbol] flips to |1 [symbol] ). A π/2-pulse on the blue sideband applied to a qubit transforms the combined qubit-motional state |0 [symbol] |nₚₕ [symbol] ₘ into a superposition of |0 [symbol] |nph) and |1 [symbol] |nₚₕ+1 [symbol] ₘ. A π/2-pulse on the red sideband applied to a qubit transforms the combined qubit-motional |0 [symbol] |nph>m into a superposition of |0)|nph) and | 1) |nph-1) . When the two-photon Rabi frequency ω(t) is smaller as compared to the detuning frequency δ=ω₁−ω₂−ω₀₁=γμthe blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Hybrid Quantum-Classical Computing System

While currently available quantum computers may be noisy and prone to errors, a combination of both quantum and classical computers, in which a quantum computer is a domain-specific accelerator, may be able to solve optimization problems that are beyond the reach of classical computers. An example of such optimization problems is joint modeling of a set of variables by a generative learning algorithm based on a dependence function, referred to as a “copula” function C in probability theory and statistics. Since copulas enable one to conveniently treat the marginal distribution of each variable and the interdependencies among variables separately, they have become an essential analysis tool on classical computers in various fields ranging from quantitative finance and civil engineering to signal processing and medicine.

The copula-based algorithm relies on transformation of a joint distribution F(x₁, . . . , xₙ) into a set of marginal distribution functions F₁(x1), . . . , Fₙ(xₙ) with a copula function C, for a set of random variables (x₁, . . . , xₙ)∈ [symbol] , each of which has an uniform distribution in [0,1]. The transformation by the copula function C: [0,1]ⁿ→>[0,1] is described as

$$F ( {x}_{1} , … , {x}_{n} ) = C ( {F}_{1} ( {x}_{1} ) , … , {F}_{n} ( {x}_{n} ) ) , \qquad ( 1 )$$

$$or$$

$$C ( {u}_{1} , … , {u}_{n} ) = F ( {F}_{1}^{- 1} ( {u}_{1} ) , … , {F}_{n}^{- 1} ( {u}_{n} ) ) , \qquad ( 2 )$$

where (u₁, . . . , uₙ)∈[0,1]ⁿ are transformed variables (i.e., u₁=F₁(x₁), . . . , uₙ=Fₙ(xₙ))). Using M samples of n variables (x₁, . . . , xₙ), or M pseudo-samples of transformed variables (u₁, . . . , uₙ), and M values of joint distribution Q₀=F(x₁, . . . , xₙ), the copula function C is estimated, which allows predicting samples (y₁, . . . , yₙ)∈ [symbol] .

In the generative learning algorithm run on a hybrid quantum-classical computing system, the copula function C that fits samples of a set of variables and corresponding joint distribution Q₀ (referred to as “target joint distribution”) is derived by iterating computations between a quantum processor and a classical computer. The derived copula function C then can be used to generate predicted samples of the set of variables. A trial copula function C is described by a parametrized quantum circuit applied on the quantum processor in which the set of variables are represented by qubits. The qubits are measured after the parameterized quantum circuit is applied to estimate joint distribution P of new samples that are generated by the trial copula function C. The classical computer receives this estimated joint distribution P, modifies (e.g., trains) the parametrized quantum circuit by an optimization algorihtm, and returns the modified parameterized quantum circuit to the quantum processor. This iteration is repeated until the estimated joint distribution P received from the quantum processor is within a predetermined difference from the target joint distribution Q₀. The resulting parametrized quantum circuit is an approximation to the copula function C. A trial copula function C would require exponentially large resource to represent on a classical computer, as the number of variables increases, but only require linearly-increasing resource on a quantum processor. Thus, the quantum processor acts as an accelerator for the copula function derivation sub-routine of the computation. Therefore, the hybrid quantum-classical computing system may allow challenging optimization problems to be solved, such as small but challenging joint modeling problems, which are not practically feasible on classical computers, or suggest ways to speed up the computation with respect to the results that would be achieved using the best known classical algorithm.

In the embodiments described herein, the estimated joint distribution P received from the quantum processor is compared to an adaptive target distribution Q(η)=ηu+(1−n)Q₀(0<η<1) (e.g., a mixture of u with Q), instead of the target joint distribution Q₀ itself, where u is a uniform joint distribution of all possible outputs of variables and n is referred to as an “annealing temperature” or a “mixing coefficient.” This is similar to what is known as adiabatic thermal annealing in the art and the training of the parameterized quantum circuits can be performed adiabatically, and thus referred to as “annealing training.” That is, the training starts a relatively large annealing temperature μ (for example, 0.8) after initializing parameters in the parameterized quantum circuits, then continues with ramping down steps in which the annealing temperature η gradually decreases to zero, similar to adiabatic thermal annealing starting with a low temperature. Analogous to the annealing process, as long as the ramping down step size δη is sufficiently small, there should be a high chance that minima obtained from the last ramping down step are close to those of the target joint distribution Q₀.

The annealing training method described herein may be used to analyze and predict, for example, returns of four stock market indices, Dow Jones Industrial Average (DJI), Market Volatility Index (VIX), Japan Nikkei Market Index (N225), and Russell 2000 Index (RUT). These stock market indices are easily accessible and have long periods of time, for example, from Jan. 4, 2001 to Dec. 30, 2020. These years reflect the vicissitudes of the market environment, such as multiple financial crashes and booms. On the one hand, DJI and RUT highlight the long-term performance of the U.S. market with their limited selection bias, and are highly positively correlated. On the other hand, N225 represents a foreign index with mild dependence with the U.S. market and VIX, as a market fear gauge, commonly negatively correlates with market indices. Thus, through empirical evaluations on those data, performance of different approaches may be evaluated in various domains in the dependence spectrum.

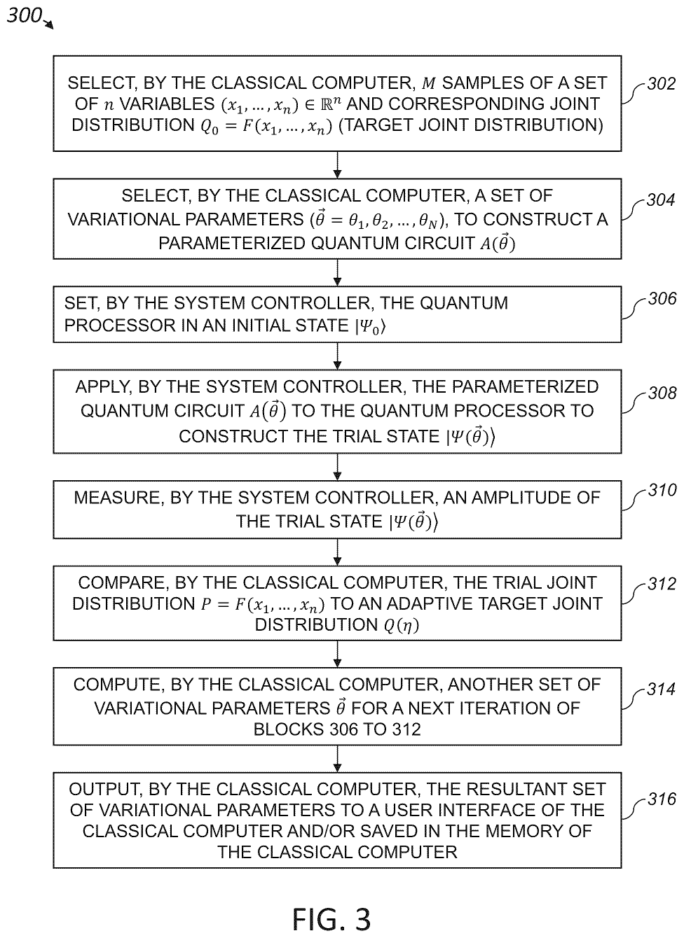

FIG. 3 depicts a flowchart illustrating a method 300 of obtaining a solution to an optimization problem by annealing training based on copulas on a hybrid quantum-classical computing system according to one embodiment. In this example, the quantum processor is the ion chain 106, in which the two hyperfine states of each of the trapped ions form a qubit.

The method 300 begins with block 302, in which, by the classical computer 102, M samples of a set of n variables (x₁, . . . , xₙ)∈ [symbol] ⁿ are inputted, for example, by use of a user interface of the classical computer 102, or retrieved from the memory of the classical computer 102, and corresponding joint distribution Q₀=F(x₁, . . . , xₙ) (target joint distribution) are computed from the inputted set of n variables, according to Eqs. (1) and (2). Further, pseudo-samples (u₁, . . . , uₙ)∈[0,1]ⁿ are generated, where uᵢ(i=1, 2, . . . , n) is a cumulative distribution function (CDF) of the variable xᵢ (i.e., uᵢ=Fᵢ(xᵢ)).

In the embodiments described herein, the n-variable copula C(u₁, . . . , uₙ) is discretized to precision of m bits per variable by using m×n qubits. These qubits are divided evenly among n registers, where each register having m qubits represents one of the variables. The real-valued pseudo samples (u₀, . . . , uₙ₋₁) are digitized into binary strings. The binary strings of all variables are then concatenated into a single binary string. The pseudo-samples (u₀, . . . , uₙ₋₁) can be written as (d₀, . . . , dₙ₋₁) with dᵢ∈|0,1), and then converted into binary-valued samples (bo, . . . , bₙ₋₁), where bᵢ is the largest m-digit binary number bᵢ=b_{i,0} . . . b_{i,m-1} that

$$\frac{1}{{2}^{m}} {\sum }_{j = 0}^{m - 1} {b}_{i , j} {2}^{j} \leq {d}_{i} .$$

Here b_{i,j} stands for the j-th digit of bᵢ. Then the digitized binary representation is combined into a single binary number B=Σᵢ₌₀ⁿ⁻¹bᵢ2^{m×i}, which can be represented by m qubits.

Examples of variables include stock market indices, such as Dow Jones Industrial Average (DJI), Market Volatility Index (VIX), Japan Nikkei Market Index (N225), and Russell 2000 Index (RUT), over a period of time.

In block 304, by the classical computer 102, a set of variational parameters (\vec{θ}=θ₁, θ₂, . . . , θ_{N}) is selected, to construct a parameterized quantum circuit A(\vec{θ}), which is a sequence of gates and prepares the quantum processor 106 in a trial state |Ψ(\vec{θ}) [symbol] . This trial state |Ψ(\vec{θ}) [symbol] is used to provide generated samples according to the measurement as described below. The number N of variational parameters equals the number of single-qubit gates and two-qubit gates in the parametrized quantum circuit A(\vec{θ}) (i.e., n×m×L), where L is the number of layers in the parameterized quantum circuit A(\vec{θ}). For the initial iteration, a set of variational parameters \vec{θ} may be chosen randomly.

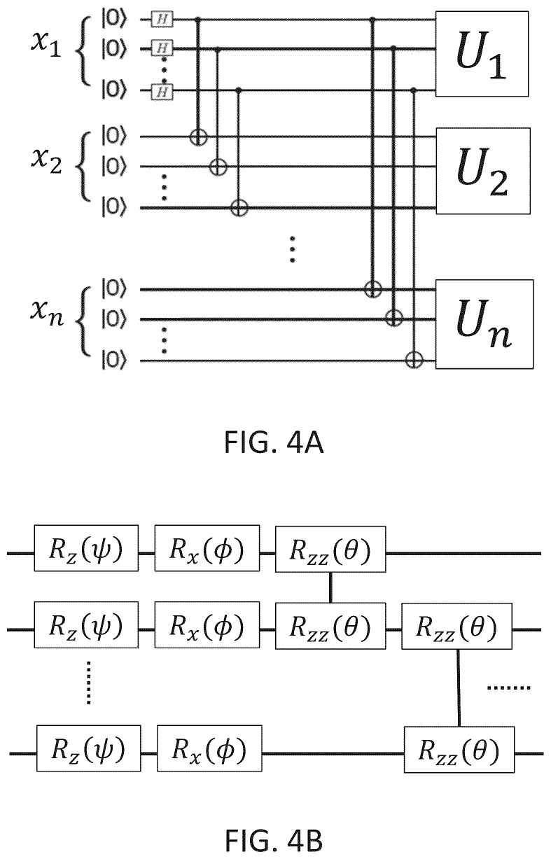

The parameterized quantum circuit A(\vec{θ}) includes unitary transformations, denoted by U₁, . . . , Uₙ in FIG. 4A, on each of the n registers. Each unitary transformation Uᵢ contains layers of a parameterized quantum circuit unit shown in FIG. 4B. Each parameterized quantum circuit unit includes a single-qubit rotation gate along the z-axis,

$${R}_{z} ( ψ ) = exp ( - i \frac{1}{2} ψ {\hat{σ}}_{z} ) ,$$

on each qubit, a single-qubit rotation gate along the x-axis,

$${R}_{x} ( ϕ ) = exp ( - i \frac{1}{2} ϕ {\hat{σ}}_{x} ) ,$$

on each qubit, and twp-qubit totation gates R_{zz}(θ)=exp(−iθ\hat{σ}_{z}⊗\hat{σ}_{z}) on each pair of qubits, where \hat{σ}ᵢ stands for the Pauli matrices, and the three parameters ψ, ϕ, and θ correspond to the rotation angles of the gates. Here ⊗ is the tensor product, which indicates that the two Pauli matrices are applied on two different qubits. The parameterized quantum circuit units are optimized for hardware implementation. The above construction of the unitary transformation Uᵢ not only reduces the number of free parameters in optimization, but also maximizes the use of the R_{z} gates, which can be implemented without accumulating errors.

In block 306, by the system controller 104, the quantum processor 106 is set in an initial state |Ψ₀ [symbol] . In the initial state |Ψ₀ [symbol] , each of the n registers having m qubits is in a maximally entangled state (referred to as “Greenberger-Horne-Zeilinger (GHZ) states”)

$$\vert {Ψ}_{GHZ} 〉 = \frac{1}{\sqrt{2}} ( \vert 00 … 0 〉 + \vert 11 … 1 〉 ) .$$

A general qyuantum state on k qubits:

$$\vert Ψ 〉 = {\sum }_{i = 0}^{{2}^{k} - 1} {c}_{i} \vert i 〉 , \qquad ( 3 )$$

where |i [symbol] (|0 [symbol] or |1 [symbol] ) are “computational basis states,” and cᵢ are complex numbers with the condition that Σᵢ|cᵢ|²=1, can be prepared by application of a proper combination of single-qubit operations and two-qubit operations to qubits which are all initialized to the |0 [symbol] state. A qubit can be set in the |0 [symbol] state by optical pumping. A GHZ state can be prepared by application of a proper combination of single-qubit operations and two-qubit operations to qubits that are prepared in the |0 [symbol] state.

In block 308, by the system controller 104, the parameterized quantum circuit A(\vec{θ}) is applied to the quantum processor 106 to construct the trial state |Y(\vec{θ}) [symbol] . The parameterized quantum circuit A(\vec{θ}) can be implemented by application of a series of laser pulses, intensities, durations, and detuning of which are appropriately adjusted by the classical computer 102, to the quantum processor 106. The quantum processor is transformed from the initial state |Ψ₀ [symbol] to the trial state |Ψ(\vec{θ}) [symbol] .

In block 310, by the system controller 104, an amplitude of the trial state |Ψ(\vec{θ}) [symbol] is measured, by collecting fluorescence from each trapped ion and mapping onto the PMT 110. The measured amplitude of the trial state |Ψ(\vec{θ}) [symbol] corresponds to a trial joint distribution=F (x₁, . . . , xₙ).

In block 312, by the classical computer 102, the trial joint distribution P=F(x₁, . . . , xₙ) is compared to an adaptive target joint distribution Q(η)=ηu+(1−η)Q₀(0<n≤1) (e.g., a mixture of u with Q₀), where u is a uniform joint distribution of all possible outputs of variables and η is an annealing temperature (also referred to as a mixing coefficient). For the initial iteration, a relatively large annealing temperature η of between about 0.5 and about 1, for example, 0.8, may be chosen. The difference between the generated trial joint distribution P and the target joint distribution Q(η) is quantified by a cost function in the form of the Kullback-Leibler (KL)-divergence:

$${D}_{KL} ( P , Q ( η ) ) = {\sum }_{s a m p l e s} P log ( \frac{P}{Q ( η )} ) , \qquad ( 4 )$$

or the clipped version of the KL-Divergence as:

$${D}_{KL} ( P , Q ( η ) ) = {\sum }_{samples} P log ( \frac{P ( x )}{max ( Q ( η ) , ϵ )} ) . \qquad ( 5 )$$

The value of ϵ should be small enough so that it keeps the behavior of the KL-Divergence intact, yet large enough to prohibit numerical singularity, for example, ϵ=10⁻⁸.

If the KL-Divergence is less than a predetermined value (i.e., the KL-Divergence sufficiently converges towards a fixed value), the method proceeds to block 316. If the difference between the two values is more than the predetermined value, the method proceeds to block 314.

In block 314, by the classical computer 102, another set of variational parameters \vec{θ} for a next iteration of blocks 306 to 312 is computed, in search for an optimal set of variational parameters \vec{θ} to estimate the copula function C. That is, the classical computer 102 executes a classical optimization method to find the optimal set of variational parameters \vec{θ}. Example of conventional classical optimization methods include simultaneous perturbation stochastic approximation (SPSA), particle swarm optimization (PSO), Bayesian optimization (BO), and Nelder-Mead (NM).

In the next iteration of blocks 306 to 312, the annealing temperature η is decreased by a predetermined step size δη. The step size δη may be between about 0.01 and about 0.1.

In block 316, by the classical computer 102, the resultant set of variational parameters is outputted to a user interface of the classical computer 102 and/or saved in the memory of the classical computer 102. The set of variational parameters in the parametrized quantum circuit, corresponding to the estimated copula function C, may be used to generate predicted samples of the set of variables, for example, predicted returns of the stock market indices.

### EXAMPLES

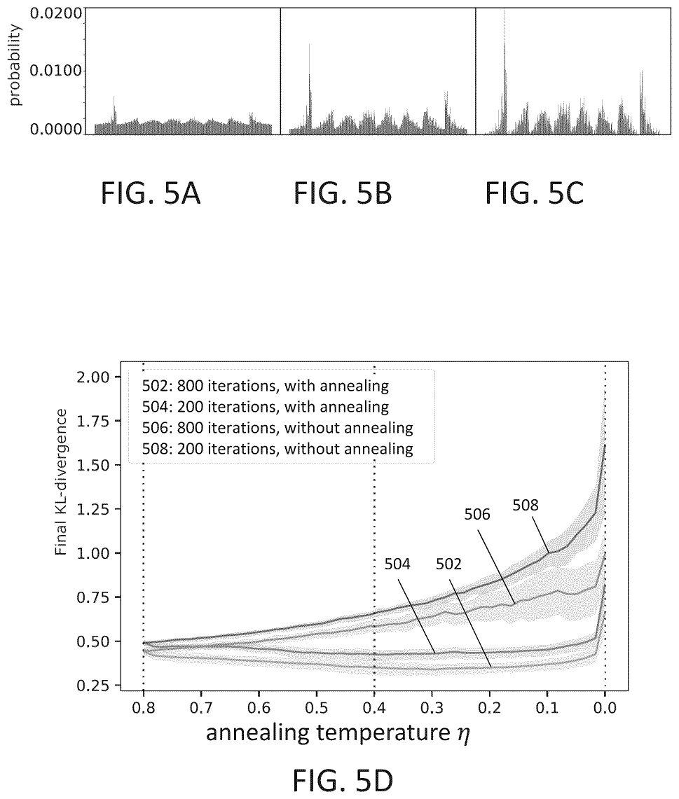

FIGS. 5A, 5B, 5C, and 5D illustrate comparison results of the annealing training method and a conventional training method without annealing training. FIGS. 5A, 5B, and 5C illustrate histograms of values of measured samples for which an initial annealing temperature n was set 0.8, 0.4, and 0, respectively. The annealing temperature was ramped down gradually by a step size δη=0.02 in each iteration and decreased to zero. The training was repeated by 800 and 200 iterations. FIG. 5D illustrates the KL-divergence, as optimization results, obtained with annealing training (800 interations in 502, 200 iterations in 504) and without annealing training (800 iterations in 506, 200 iterations in 508).

With the same training method, more training iterations generate better training results (e.g., smaller value of the KL-divergence). It can be seen that results obtained from annealing training outperform results obtained from standard training, even with 4-fold reduction in training iterations. It can also been seen that the standard deviation of training results, from stochastically choosing initial parameters, is smaller in annealing training. This is expected because through the annealing training process, as the level of the induced noise decreases, the minima will shift with the transformation of the adaptive target distribution. However, as long as such transformation is slow (adiabatic), the classical optimizer should drive the parameters to follow the shift of the minima. This also explains why annealing training can reach better results with fewer iterations.

In the embodiments described herein, an annealing training method for obtaining a solution to an optimization problem on a hybrid quantum-classical computing system is provided. The annealing training provides reliable solutions to optimization problems, without issues such as bad local minima and vanishing gradients that are common in conventional optimization methods.

While the foregoing is directed to specific embodiments, other and further embodiments may be devised without departing from the basic scope thereof, and the scope thereof is determined by the claims that follow.

1. A method of performing computation in a hybrid quantum-classical computing system comprising a classical computer and a quantum processor, comprising:
selecting, by a classical computer, samples of a set of variables and a target joint distribution of the set of variables;
selecting, by the classical computer, a set of variational parameters to construct a parametrized quantum circuit;
executing iterations, each iteration comprising:
setting, by a system controller, a quantum processor in an initial state, wherein the quantum processor comprises a plurality of trapped ions, each of which has two frequency-separated states defining a qubit;
applying, by the system controller, the parametrized quantum circuit to the quantum processor based on the set of the variational parameters, to transform the quantum processor from the initial state to a trial state;
measuring, by the system controller, an amplitude of the trial state, to generate a trial joint distribution of the set of variables; and
replacing, by the classical computer, the set of the variational parameters with another set of variational parameters, if a difference between the generated trial joint distribution of the set of variables and an adaptive target joint distribution based on the target joint distribution and a mixing coefficient is more than a predetermined value; and
outputting the set of the variational parameters,
wherein the adaptive target joint distribution is a mixture of a uniform joint distribution of the set of variables with the target joint distribution, and the mixing coefficient is decreased in each iteration.

2. The method of claim 1, wherein the parametrized quantum circuit comprises single-qubit rotation gates and two-qubit rotation gates.

3. The method of claim 1, wherein in the initial state, each register comprising a plurality of qubits and representing one of the set of variables is in a maximally entangled state.

4. The method of claim 1, wherein the set of variational parameters is initially selected randomly.

5. The method of claim 1, wherein the mixing coefficient is in the initial iteration is between 0.5 and 1.

6. The method of claim 1, wherein the mixing coefficient is decreased by between 0.01 and 0.1 in each iteration.

7. A hybrid quantum-classical computing system, comprising:
a quantum processor comprising a plurality of trapped ions, each of the trapped ions having two hyperfine states defining a qubit;
one or more lasers configured to emit a laser beam, which is provided to trapped ions in the quantum processor;
a classical computer configured to:
select samples of a set of variables and a target joint distribution of the set of variables;
select a set of variational parameters to construct a parametrized quantum circuit;
execute iterations, each iteration comprising:
instructing a system controller to set the quantum processor in an initial state;
instructing the system controller to apply the parametrized quantum circuit to the quantum processor based on the set of the variational parameters, to transform the quantum processor from the initial state to a trial state;
instructing the system controller to measure an amplitude of the trial state, to generate a trial joint distribution of the set of variables; and
replacing the set of the variational parameters with another set of variational parameters, if a difference between the generated trial joint distribution of the set of variables and an adaptive target joint distribution based on the target joint distribution and a mixing coefficient is more than a predetermined value; and
output the set of the variational parameters,
wherein the adaptive target joint distribution is a mixture of a uniform joint distribution of the set of variables with the target joint distribution, and the mixing coefficient is decreased in each iteration.

8. The hybrid quantum-classical computing system of claim 7, wherein each of the trapped ions is ¹⁷¹Yb⁺ having the ²S_{1/2} hyperfine states.

9. The hybrid quantum-classical computing system of claim 7, wherein each of the trapped ions is one selected from Be⁺, Ca⁺, Sr⁺, Mg⁺, Ba⁺, Zn⁺, Hg⁺, Cd⁺.

10. The hybrid quantum-classical computing system of claim 7, wherein the parametrized quantum circuit comprises single-qubit rotation gates and two-qubit rotation gates.

11. The hybrid quantum-classical computing system of claim 7, wherein in the initial state, each register comprising a plurality of qubits and representing one of the set of variables is in a maximally entangled state.

12. The hybrid quantum-classical computing system of claim 7, wherein the set of variational parameters is initially selected randomly.

13. The hybrid quantum-classical computing system of claim 7, wherein the mixing coefficient is in the initial iteration is between 0.5 and 1.

14. The hybrid quantum-classical computing system of claim 7, wherein the mixing coefficient is decreased by between 0.01 and 0.1 in each iteration.

15. A hybrid quantum-classical computing system comprising non-volatile memory having a number of instructions stored therein which, when executed by one or more processors, causes the hybrid quantum-classical computing system to perform operations comprising:
selecting, by a classical computer, samples of a set of variables and a target joint distribution of the set of variables;
selecting, by the classical computer, a set of variational parameters to construct a parametrized quantum circuit;
executing iterations, each iteration comprising:
setting, by a system controller, a quantum processor in an initial state, wherein the quantum processor comprises a plurality of trapped ions, each of which has two frequency-separated states defining a qubit;
applying, by the system controller, the parametrized quantum circuit to the quantum processor based on the set of the variational parameters, to transform the quantum processor from the initial state to a trial state;
measuring, by the system controller, an amplitude of the trial state, to generate a trial joint distribution of the set of variables; and
replacing, by the classical computer, the set of the variational parameters with another set of variational parameters, if a difference between the generated trial joint distribution of the set of variables and an adaptive target joint distribution based on the target joint distribution and a mixing coefficient is more than a predetermined value; and
outputting the set of the variational parameters,
wherein the adaptive target joint distribution is a mixture of a uniform joint distribution of the set of variables with the target joint distribution, and the mixing coefficient is decreased in each iteration.

16. The hybrid quantum-classical computing system of claim 15, wherein the parametrized quantum circuit comprises single-qubit rotation gates and two-qubit rotation gates.

17. The hybrid quantum-classical computing system of claim 15, wherein in the initial state, each register comprising a plurality of qubits and representing one of the set of variables is in a maximally entangled state.

18. The hybrid quantum-classical computing system of claim 15, wherein the set of variational parameters is initially selected randomly.

19. The hybrid quantum-classical computing system of claim 15, wherein the mixing coefficient is in the initial iteration is between 0.5 and 1.

20. The hybrid quantum-classical computing system of claim 15, wherein the mixing coefficient is decreased by between 0.01 and 0.1 in each iteration.
